(19) United States
(12) Patent Application Publication
(10) Pub. No.: US 2009/0028026 A1
(43) Pub. Date: Jan. 29, 2009

(54) METHOD AND APPARATUS FOR COLLECTING PARAMETERS OF AN OPTICAL DISC DRIVE

(75) Inventor: HUAN-CHIEH TSENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/966,994

(22) Filed: Dec. 29, 2007

(30) Foreign Application Priority Data
Jul. 23, 2007 (CN) 200710201155.1

(51) Int. Cl. G11B 3/64

(52) U.S. Cl. 369/85

(57) ABSTRACT

A method is provided of collecting parameters stored in a flash read only memory of optical disc drive. The method includes inserting an optical disc to the optical disc drive; identifying if the optical disc is specially formatted; determining if the optical disc having sufficient space for recording data thereto; recording the parameters stored in the flash read only memory to the optical disc.

### BACKGROUND

1. Field of the Invention

The present invention generally relates to methods and apparatuses of optical disc drives, and more particularly, relates to a method and an apparatus for collecting parameters of an optical disc drive.

2. Description of Related Art

Referring to FIG. 3, an optical disc drive 202 includes a flash read-only memory (flash ROM) 210. The flash ROM 210 stores various parameters for controlling operations of various components of the optical disc drive 202. Such parameters include read/write power of laser beams emitted from a laser diode, rotation speed of a spindle motor, tray loading/unloading speed and so on.

In manufacturing process, incoming components such as optical pick-up units (OPUs) may have different optimum read powers for reading optical disc. After the optical disc drives are assembled, the read powers of the OPU are adjusted to the optimal values by updating corresponding parameters stored in the Flash ROM 210. In practice, the read powers parameters are often collected to make statistical analyses. Conventionally, these parameters are collected by a host machine 204 such as a PC connected to the optical disc drive 20. The host machine 204 sends an inquiry command to the optical disc drive 202 to access the parameters stored in the Flash ROM 212. The accessed parameters then are stored in a storage unit 210 of the host machine 204 for further statistical analysis.

However, in mass production, it is time-consuming and inconvenient to collect these parameters stored in the Flash ROM 210. In that, the optical disc drives 202 must be repeatedly connected and reconnected to the host machine 204 to access the data stored in the Flash ROM 210.

Therefore, what is desired in the industry is to provide a method and apparatus for collecting parameters of the optical disc drive more easily.

### SUMMARY

Accordingly, a method is provided for collecting parameters stored in a flash read only memory of optical disc drive, an exemplar embodiment of the method includes inserting an optical disc to the optical disc drive; identifying if the optical disc is specially formatted; determining if the optical disc having sufficient space for recording data thereto; recording the parameters stored in the flash read only memory to the optical disc. Moreover, an optical disc drive is provided for implementing the method.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a block diagram of an optical disc drive according to an exemplary embodiment;

FIG. 2 is a flowchart for collecting parameters of the optical disc drive as illustrated in FIG. 1.

FIG. 3 is a conventional apparatus for collecting parameters of optical disc drive.

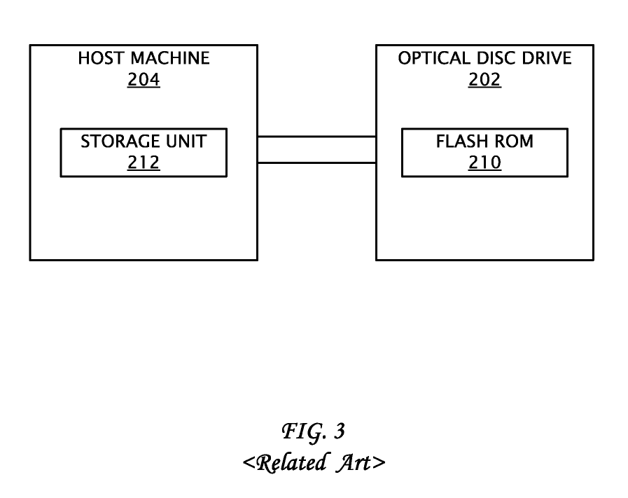

### DETAILED DESCRIPTION

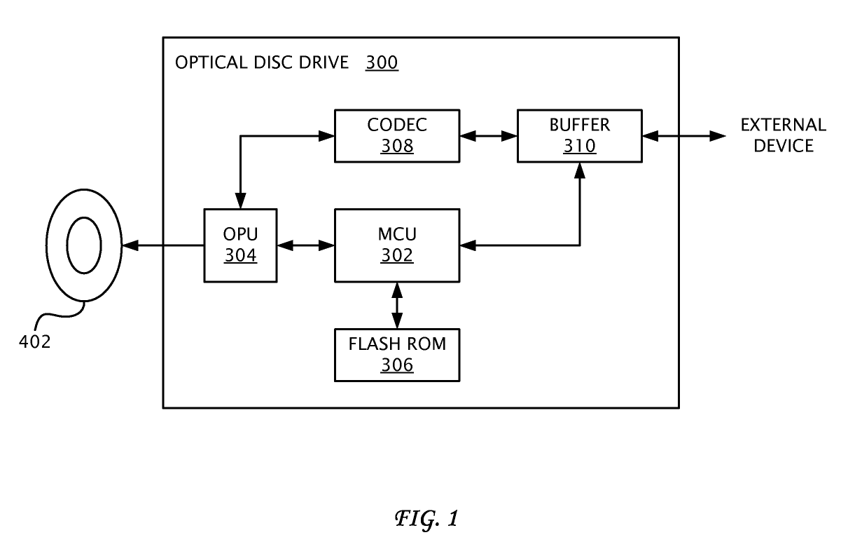

Referring to FIG. 1, an optical disc drive 300 of an exemplary embodiment may be used for recording information from an external device such as a personal computer (PC) to an optical disc 402. The optical disc drive 300 includes a micro control unit (MPU) 302, an optical pick-up unit (OPU) 304, a flash read only memory (Flash ROM) 306, a codec 308, and a buffer 310. The OPU 304 projects laser beams to the optical disc 402 and receiving laser beams reflected from the optical disc 402 controlled by the MCU 302. The OPU 304 supplies radio frequency (RF) signals to the codec 308. The codec 308 applies eight-fourteen modulated (EFM) demodulation corresponding to a CD standard or eight-sixteen modulated demodulation corresponding to a DVD standard to the RF signals to obtain reproduced data. The reproduced data may be temporarily stored in the buffer 310 and transferred to the external device.

The Flash ROM 306 stores parameters for controlling operations of various components of the optical disc drive 300. Such parameters include read/write power of laser beams emitted from a laser diode, rotation speed of a spindle motor, tray loading/unloading speed and so on. The parameters are read by the MCU 302 and applied to various components of the optical disc drive 300. The parameters stored in the Flash ROM 306 can be modified by updating the data stored in the buffer 310 under control of the MCU 302.

In mass production, in order to efficiently generate a statistical analysis, the parameters stored in the Flash ROM 306 are recorded to the optical disc 402. The optical disc 402 is preformatted by recording predetermined data to data areas of the optical disc 402. Such that, the formatted optical disc 402 can be identified and used specifically for storing parameters in the Flash ROM 306. For example, a predetermined data “firmware disc” is recorded to a data area having a starting address of 30000h of a DVD disc.

To record parameters stored in the Flash ROM 306 to the optical disc 402, the parameters are transferred to the buffer 310 controlled by the MCU 302. The codec 308 then encodes the parameters to EFM modulated data or eight-sixteen modulated data. The EFM modulated data or the eight-sixteen modulated data are converted into pulse signals. The pulse signals modulate laser beams that emit from the OPU 304 and project to the optical disc 402, thereby the parameters in the Flash ROM 306 are recorded to the optical disc 402.

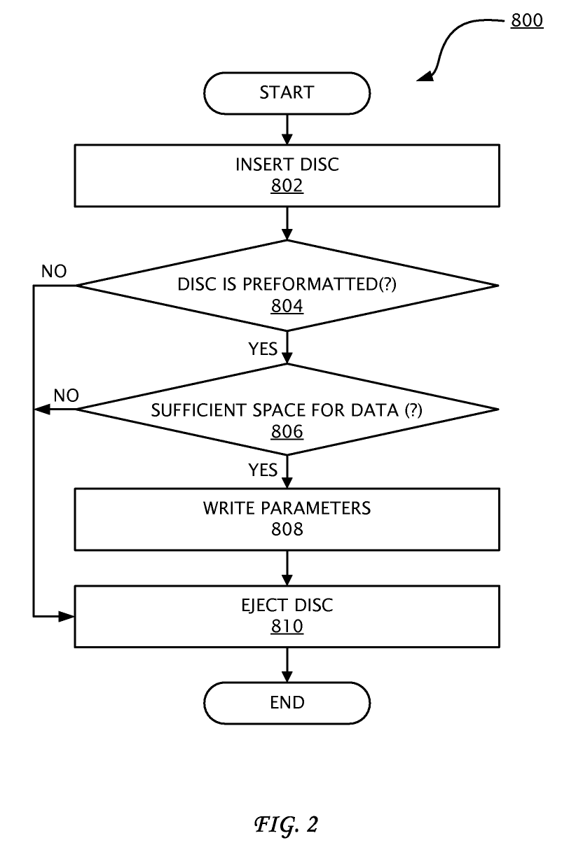

Referring to FIG. 2, a method 800 for recording parameters stored in the Flash ROM 306 of the optical disc drive 300 will be described. In some embodiments, the method 800, or portions thereof, may be performed by the optical disc drive 300 as described above, although the method 800 is not limited by the particular type of apparatus, software element, or system performing the method. The various actions in the method 800 may be performed in the order presented, or may be performed in a different order. Further, in some embodiments, some actions listed in FIG. 2 may be omitted from the method 800.

At block 802, an optical disc is inserted. In manufacturing, the optical disc 402 is inserted to the optical disc drive 300.

At block 804, a judgment is implemented for identifying if the optical disc 402 is a preformatted disc. This can be done by reading out the predetermined data recorded in the data area having a start address of 3000h of a DVD disc. If the predetermined data is “firmware disc”, then the optical disc 402 is determined to be a preformatted disc. If the optical disc is determined not to be a preformatted disc, the optical disc 402 is ejected at block 410.

At block 806, a judgment is implemented for determining if there is sufficient space in the optical disc 402 to record data thereto. If there is no sufficient space in the optical disc 402, that is, the optical disc 402 is full, then the optical disc 402 is ejected at block 410.

At block 808, if the optical disc 402 has sufficient space, the parameters stored in the Flash ROM 306 are recorded to the optical disc 402.

At block 810, if the parameters stored in the Flash ROM 306 are recorded, the optical disc 402 is ejected.

As described above, the parameters stored in the Flash ROM 306 of the optical disc drive 300 is recorded to the optical disc 402 for making a statistical analysis. As the optical disc 402 has a large capacity, such that it is more easily to collect the parameters comparing to repeatedly connecting the optical disc drive 300 to a PC to access the parameters.

Alternative embodiments will become apparent to those skilled in the art to which the present invention pertains without departing from its spirit and scope.

What is claimed is:

1. A method for collecting parameters stored in a flash read only memory of an optical disc drive, the method comprising:
identifying if the optical disc is preformatted according to predetermined standard;
determining if the optical disc having sufficient space for recording data thereto;
recording the parameters stored in the flash read only memory of the optical disc drive to the optical disc if the optical disc has sufficient space.

2. The method as described in claim 1, further comprising inserting an optical disc to the optical disc drive.

3. The method as described in claim 1, further comprising ejecting the optical disc if the optical disc is identified not to be a preformatted disc according to a predetermined standard.

4. The method as described in claim 1, further comprising ejecting the optical disc if the optical disc has no sufficient space for storing data.

5. The method as described in claim 1, further comprising manufacturing the preformatted disc by recording predetermined data to a data area of the optical disc.

6. The method as described in claim 1, wherein recording the parameters stored in the flash read only memory comprising transferring the parameters to a buffer of the optical disc drive.

7. The method as described in claim 6, wherein recording the parameters stored in the flash read only memory further comprising encoding the parameters to eight-sixteen modulated signals.

8. An optical disc drive for recording data to or reproducing data from an optical disc, comprising:
a micro control unit;
an optical pick-up unit controlled by the micro control unit for irradiating laser beams to the optical disc;
a flash read only memory storing parameters of read power of the laser beams, the read power parameters being read out under control of the micro control unit and recorded to the optical disc by the optical pick-up unit.

9. The optical disc drive as described in claim 8, wherein the optical disc drive further comprises a buffer, and the parameters are transferred to the buffer before being recorded to the optical disc.

10. The optical disc drive as described in claim 8, wherein the optical disc drive further comprises a codec, and the parameters stored in the flash read only memory are encoded to eight-fourteen modulated signals.

11. The optical disc drive as described in claim 8, wherein the parameters stored in the flash read only memory are encoded to eight-sixteen modulated signals.

12. The optical disc drive as described in claim 10, wherein the parameters stored in the flash read only memory are recorded to data areas of the optical disc.
